(19) United States
(12) Patent Application Publication
(10) Pub. No.: US 2015/0194244 A1
(43) Pub. Date: Jul. 9, 2015

(54) NEGATIVE CHARACTERISTIC THERMISTOR AND MANUFACTURING METHOD THEREFOR

(71) Applicant: MURATA MANUFACTURING CO., LTD., Nagaokakyo-shi (JP)

(72) Inventor: Yuichi Hirata, Nagaokakyo-shi (JP)

(21) Appl. No.: 14/559,988

(22) Filed: Dec. 4, 2014

(30) Foreign Application Priority Data
Jan. 9, 2014 (JP) 2014-002697

(51) Int. Cl. H01C 7/00; H01C 17/00; H01C 7/04

(52) U.S. Cl. CPC H01C 7/008; H01C 7/042; H01C 17/00

(57) ABSTRACT

A laminated chip-type negative characteristic thermistor of 0603 size or less, which includes: a ceramic element of a ceramic material containing Mn and Ni as its main constituents and containing Ti; and an internal electrode containing Pd ratio of 70 weight % or more.

### BACKGROUND OF THE INVENTION

1. Field of the Invention

The present invention relates to a negative characteristic thermistor and a manufacturing method therefor.

2. Description of the Related Art

In recent years, surface-mount electronic components have been required, and there have been advances in the fabrication of negative-characteristic thermistors in chip form. Such a chip of laminate-type negative characteristic thermistor (laminated chip-type negative characteristic thermistor) is disclosed in, for example, Japanese Patent Application Laid-Open No. 2004-104093.

The laminated chip-type negative characteristic thermistor disclosed in Japanese Patent Application Laid-Open No. 2004-104093 is composed of a ceramic body including: a plurality of ceramic layers which have negative resistance-temperature characteristics; and a plurality of internal electrodes respectively formed along the interfaces of the ceramic layers, and external electrodes are formed on end surfaces of the ceramic body so as to provide conduction to the internal electrodes.

In this case, the ceramic layers are formed with the use of a ceramic material (thermistor material) containing Mn and Ni as its main constituents with Al added as an additive, and Pd electrodes and Ag electrodes are respectively used as the internal electrodes and the external electrodes.

Such a laminated chip-type negative characteristic thermistor is prepared in the following way. First, a ceramic powder with an organic binder added thereto is mixed to provide a slurry form, and thereafter, subjected to a forming process with the use of a doctor blade method or the like, thereby preparing ceramic green sheets. Then, a paste for internal electrodes, which contains Pd as its main constituent, is used to form an electrode pattern on the ceramic green sheets by applying screen printing. Next, the ceramic green sheets with the electrode patterns screen-printed are stacked, and then subjected to pressure bonding with the stacked sheets sandwiched between upper and lower ceramic green sheets with no electrode pattern screen-printed, thereby preparing a laminated body. Then, the laminated body obtained is subjected to binder removal treatment, and then to firing, thereby forming a ceramic body of internal electrode layers and ceramic layers alternately stacked. Further, a paste for external electrodes, which is composed of Ag or the like, is applied onto both ends of the obtained ceramic body, and baked to form external electrodes.

For surface-mounting of the thus obtained ceramic body provided with the external electrodes onto a substrate, typically, soldering is carried out. In carrying out this soldering, the external electrodes may be melted and eluted into the solder, so-called solder leach may be caused in some cases. In order to prevent this solder leach, or ensure solder wettability, it is common to form plating films such as Ni and Sn on the surfaces of the external electrodes in advance before carrying out the soldering.

It is to be noted that Japanese Patent Application Laid-Open No. 2004-104093 discloses, in a working example thereof, the use of a Mn—Ni—Al—Ti based ceramic material as the thermistor material, and the use of a Pd electrode as the internal electrodes.

Besides, Japanese Patent Application Laid-Open No. 2004-311588 discloses a working example with the use of a Mn—Ni—Al based thermistor material and Pd internal electrodes. Japanese Patent Application Laid-Open No. 2001-237105 discloses a working example with the use of a Mn—Ni—Co based thermistor material and Pd internal electrodes. Japanese Patent Application Laid-Open No. 2000-124006 discloses a working example with the use of a Mn—Ni—Cr based thermistor material and Pd internal electrodes. Japanese Patent Application Laid-Open No. 2000-106304 discloses a working example with the use of a Mn—Ni—Cu based thermistor material and Pd internal electrodes.

However, the formation of a plating film on the external electrodes formed on end surfaces of the ceramic body has the problem of a plating solution which also comes into contact with the ceramic body, resulting in ceramic body erosion. Furthermore, the ceramic body eroded by the plating solution causes a problem with decreased strength of the ceramic body. In particular, as disclosed in Japanese Patent Application Laid-Open No. 2004-104093, the ceramic body 14 formed with the use of the thermistor material containing Mn and Ni as its main constituents and containing Al has an advantageous effect of excellent reliability because of small variations with time, but at the same time, fails to sufficiently prevent the erosion caused by the plating solution.

In order to solve these conventional problems, the use of a Mn—Ni—Ti based ceramic material as the thermistor material has been examined. For example, International Publication WO 2006/085507 discloses the use of a Mn—Ni—Ti based ceramic material as the thermistor material, and the use of internal electrodes composed of AgPd or the like containing 60 to 90 weight % of Ag. Japanese Patent No. 5064286 discloses the use of a Mn—Ni—Ti based ceramic material as the thermistor material, and the use of internal electrodes containing at least Ag.

In the laminate-type negative characteristic thermistors which use the Mn-based ceramic material as mentioned above, AgPd, Pd, or the like is used as a material for the internal electrodes. In addition, the laminate-type negative characteristic thermistors which use the Mn—Ni—Ti based material as disclosed in International Publication WO 2006/085507 and Japanese Patent No. 5064286 have compositions that are able to be fired in a relatively low temperature range (900° C. to 1100° C.), and thus the use of AgPd internal electrodes with a high Ag ratio is preferred. This is because the Ag ratio increased to the extent that volatilization in the firing process causes no problem is advantageous in terms of cost, due to the fact that Ag is considerably more inexpensive than Pd.

### SUMMARY OF THE INVENTION

When the laminated chip-type negative characteristic thermistor is reduced in element size, the outer layer distance from the section with the internal electrodes formed to the ambient environment is shortened. For this reason, the ceramic body is more likely to be affected under high-temperature environments or humid environments, and the degree to which the body is affected depends on the sintered state of the ceramic. Therefore, in order to improve the environment resistance of the thermistor, densification of the ceramic body is the most effective way, and for the densification, it is effective to increase the firing temperature.

However, because Ag in the AgPd internal electrodes has a low melting point, the increased firing temperature makes Ag more likely to be volatilized during the firing. Furthermore, when Ag is volatilized, Ag is volatilized from end surfaces of the laminated chip or the like. For this reason, the influence of the Ag volatilization on overlaps between the internal electrodes, which contribute largely to the resistance value which is a key characteristic of the negative characteristic thermistor, is increased as the chip is reduced in size. Furthermore, the Ag volatilization decreases the internal electrode coverage which increases the variation in resistance value, and also leads to reliability degradation such as high-temperature environment resistance or humidity resistance.

Therefore, an object of the present invention is to provide a highly reliable negative characteristic thermistor with an Mn—Ni—Ti-based material which can be reduced in element size, has high-coverage internal electrodes with a small volatilization.

The present invention relates to a laminated chip-type negative characteristic thermistor of 0603 size or less, which includes a ceramic element of a ceramic material containing Mn and Ni as its main constituents and containing Ti, and internal electrodes containing Pd ratio of 70 weight % or more. The ceramic element is preferably 24 μm or less in thickness.

Furthermore, the present invention also relates to a laminated chip-type negative characteristic thermistor of 0402 size or less, which includes a ceramic element of a ceramic material containing Mn and Ni as its main constituents and containing Ti, and internal electrodes of Pd. The ceramic element is preferably 16 μm or less in thickness.

In the laminated chip-type negative characteristic thermistors mentioned above, the ceramic elements preferably have 3.0 μm or less in ceramic average grain size.

Furthermore, the present invention also relates to a method for manufacturing the negative characteristic thermistor mentioned above, which includes a firing step at a temperature of 1100° C. or higher.

According to the present invention, for reduction in element size in the case of a negative characteristic thermistor where a Mn—Ni—Ti based material is used, the intentional use of high-melting-point electrodes (Aged electrodes with a high Pd ratio or electrodes composed of Pd) as internal electrodes can provide a highly reliable negative characteristic thermistor which has high-coverage internal electrodes with a small volatilization.

Furthermore, firing at high temperature and reduction in ceramic grain size in the fired ceramic elements densify the ceramic body, thereby providing a negative characteristic thermistor including the ceramic body which is less likely to be affected by the external environment, and also excellent in mechanical strength.

### BRIEF DESCRIPTION OF THE DRAWINGS

FIG. 1 is a graph showing a relationship between the time of leaving at high temperature and the resistance change rate in Test Example 1;

FIG. 2 is a graph showing a relationship between the internal electrode composition and the resistance change rate in Test Example 2;

FIGS. 3(a) to 3(c) are electron micrographs of ceramic element surfaces of laminated chip-type negative characteristic thermistors according to Examples 4 to 6;

FIG. 4 is a graph showing a relationship between the average grain size for ceramic grains and the resistance change rate in Test Example 3;

FIG. 5 is a graph showing a relationship between the average grain size for ceramic grains and the flexural strength in Test Example 3;

FIG. 6 is a graph showing a relationship between the internal electrode composition and the resistance change rate in Test Example 5; and

FIG. 7 is a graph showing a relationship between the average grain size for ceramic grains and the resistance change rate in Test Example 6.

### DETAILED DESCRIPTION OF THE INVENTION

### Embodiment 1

The laminated chip-type negative characteristic thermistor according to the present embodiment is a laminated chip-type negative characteristic thermistor including a ceramic element of a ceramic material containing Mn and Ni as its main constituents and containing Ti, and internal electrodes containing Pd ratio of 70 weight % or more, and having a size of 0603 size or less. The basic configuration is similar to a common configuration as described in, for example, Japanese Patent Application Laid-Open No. 2004-104093, the entire contents of which are incorporated herein by reference and the detailed descriptions of the configuration will be thus omitted.

The 0603 size herein refers to a size of 0.6 mm in a longer direction, 0.3 mm in a shorter direction, and 0.3 mm in a height direction. Further, the 1005 size refers to a size of 1.0 mm in a longer direction, 0.5 mm in a shorter direction, and 0.5 mm in a height direction.

The ceramic material constituting the ceramic body is not particularly limited as long as the material contains Mn and Ni as its main constituents (the total amount of Mn and Ni exceeds 50 weight % of the entire material) and contains Ti, but for example, the following ceramic material (1) or (2) can be used:

(1) A ceramic material containing Mn, Ni, and Ti, where the molar ratio between Mn and Ni meets 55/45≦a/b≦90/10 when the molar quantity of Mn and the molar quantity of Ni are respectively denoted by a and b, and when the total molar quantity of Mn and Ni is regarded as 100 parts by mole, the content of Ti is 0.5 parts by mole or more and 25 parts by mole or less; and

(2) A ceramic material containing Mn, Ni, Co, and Ti, where the content of Mn is 0.1 mol % or more and 90 mol % or less, the content of Ni is 0.1 mol % or more and 45 mol % or less, and the content of Co at 0.1 mol % or more and 90 mol % or less (provided that the sum of Mn, Ni, and Co is 100 mol %), and when the total molar quantity of Mn, Ni, and Co in the ceramic material is regarded as 100 parts by mole, the content of Ti is 0.5 parts by mole or more and 30 parts by mole or less.

As in the case of the ceramic materials (1) and (2), the predetermined amount of Ti contained in the material containing Mn and Ni can prevent the ceramic body from being eroded by the plating solution, and improve the strength of the ceramic body.

In the present embodiment, the ceramic element is preferably 24 μm or less in thickness. This is because the ceramic element has a thickness on the order of 16 μm, when the size of the laminated chip-type negative characteristic thermistor is the 0402 size or less. Further, a ceramic element of 1005 size has a thickness on the order of 36 μm.

In addition, ceramic crystals of the ceramic elements are preferably 3.0 μm or less in average grain size. The reduction in ceramic grain size densifies the ceramic body, thereby providing a negative characteristic thermistor including the ceramic body which is less likely to be affected by the external environment, and also excellent in mechanical strength. Furthermore, the reduction in ceramic grain size can reduce the ceramic element in layer thickness, thus making it easy to reduce the size of the laminated chip-type negative characteristic thermistor. In addition, it becomes possible to design the thermistor to have a desired resistance value. From the foregoing, an ultraminiature laminated chip-type negative characteristic thermistor can be provided which suppresses the variation in resistance value, and has excellent environment resistance.

### Embodiment 2

The present embodiment differs from Embodiment 1 in that the size of the laminated chip-type negative characteristic thermistor is the 0402 size or less, with the use of internal electrodes of Pd, but provides, in the other respects, the same thermistor as in Embodiment 1. The other respects are similar to a common configuration as described in, for example, Japanese Patent Application Laid-Open No. 2004-104093, the entire contents of which are incorporated herein by reference and the detailed descriptions of the configuration will be thus omitted.

The 0402 size herein refers to a size of 0.4 mm in a longer direction, 0.2 mm in a shorter direction, and 0.2 mm in a height direction.

In the present embodiment, the ceramic element is preferably 16 μm or less in thickness. This is because the ceramic element has a thickness on the order of 16 μm, when the size of the laminated chip-type negative characteristic thermistor is the 0402 size or less.

### Embodiment 3

The present embodiment provides a method for manufacturing the laminated chip-type negative characteristic thermistor described in Embodiment 1 or 2, the method including a firing step at a temperature of 1100° C. or higher. The temperature of 1100° C. or higher in the firing step can densify the fired ceramic element.

It is to be noted that the average grain size for the ceramic crystals of the fired ceramic element is preferably adjusted to 3.0 μm or less, and methods for the adjustment include, for example, a method of reducing particle sizes of a raw material powder for the ceramic element, and optimizing the amount of an organic binder in ceramic green sheets.

The manufacturing method according to the present embodiment can provide even laminated chip-type negative characteristic thermistors of 0603 size and 0402 size or less with an equivalent level of reliability to that of a large-size thermistor of 1005 size or more.

### EXAMPLES

### Example 1

In the present example, with the use of a Mn—Ni—Ti based ceramic material containing Mn, Ni, and Ti as a material for the ceramic element, a laminated chip-type negative characteristic thermistor of 0603 size, which was provided with AgPd internal electrodes containing Pd ratio of 70 weight %, was prepared by a common manufacturing method (basically the same method as the manufacturing method disclosed in Japanese Patent Application Laid-Open No. 2004-104093). However, the temperature for the firing step was adjusted to 1130° C. In the Mn—Ni—Ti based ceramic material, the content of Mn is 65 mol % and the content of Ni is 28 mol %, and furthermore, when the total molar quantity of Mn and Ni in the ceramic material is regarded as 100 parts by mole, the content of Ti is 6 parts by mole.

It is to be noted that ceramic crystals were 0.5 μm in average grain size in the ceramic element of the laminated chip-type negative characteristic thermistor obtained. It is to be noted that the measurement of the average grain size was calculated by image recognition on the surface of the ceramic element (the same applies to other examples and comparative examples).

### Comparative Example 1

A laminated chip-type negative characteristic thermistor of 0603 size was prepared in the same way as in Example 1, except that the temperature for the firing step was adjusted to 1090° C. It is to be noted that ceramic crystals were 0.7 μm in average grain size in the ceramic element of the laminated chip-type negative characteristic thermistor obtained.

### Test Example 1

Reliability evaluations through a high-temperature storage test were made on the laminated chip-type negative characteristic thermistors according to Example 1 and Comparative Example 1.

Specifically, the laminated chip-type negative characteristic thermistors according to Example 1 and Comparative Example 1 were left in a thermostatic bath at 125° C. After a lapse of predetermined period of time (100, 300, 500, and 1000 hours) from the start of leaving the thermistors, the thermistors were taken out of the thermostatic bath, and left for a sufficient period of time under an environment at 25° C., and after the thermistors reached 25° C., the resistance value was measured for each thermistor. From the resistance value, the resistance change rate was calculated with respect to the resistance value of thermistor, which was measured in advance before the start of the test. FIG. 1 shows a relationship between the time of leaving at high temperature and the resistance change rate in a graphic form.

As shown in FIG. 1, an increase in firing temperature significantly decreases the resistance change rate, and it is determined that the environment resistance of the thermistor is significantly improved. It is to be noted that the resistance change rate of 1% or less after a lapse of 1000 hours gives a common indication for guaranteeing the reliability of the thermistor.

In the case of the thermistor of 1005 size or more, even firing carried out at 1100° C. or lower has a small influence on overlaps between the internal electrodes, which contribute largely to the resistance value which is a key characteristic of the negative characteristic thermistor, and thus not particularly problematic in terms of environment resistance. However, the small size of 0603 size or less is made more likely to be affected under high-temperature environments or humid environments, because the outer layer distance from the section with the internal electrodes formed to the ambient environment is shortened.

Accordingly, from the result in FIG. 1, in the case of the laminated chip-type negative characteristic thermistor of 0603 size or less, there is a need to enhance the environment resistance through densification of the ceramic body, and for this purpose, it is important to carry out firing at a temperature of 1100° C. or higher.

However, when the firing temperature is 1100° C. or higher, Ag volatilization is not negligible with respect to the reliability of the thermistor, and the internal electrodes with a Pd ratio of 70 weight % or more are thus used in Example 1.

### Example 2

A laminated chip-type negative characteristic thermistor was prepared in the same way as in Example 1, except for the size of 0402 size. Specifically, AgPd electrodes containing Pd ratio of 70 weight % were used as the internal electrodes.

### Example 3

A laminated chip-type negative characteristic thermistor was prepared in the same way as in Example 2, Except for the use of Pd electrodes (electrodes composed of Pd) as internal electrodes.

### Test Example 2

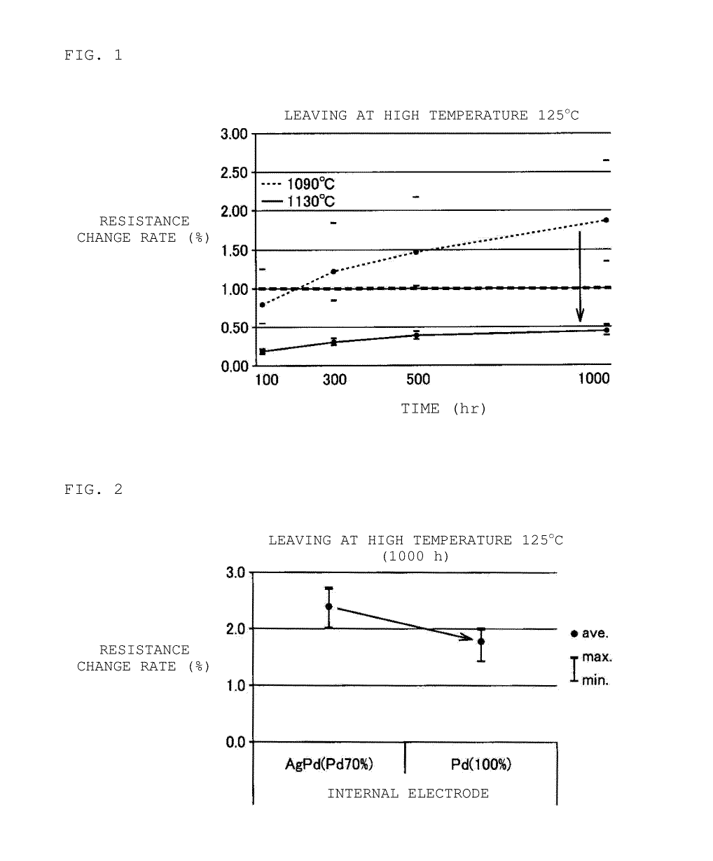

On the laminated chip-type negative characteristic thermistors according to Examples 2 and 3, reliability evaluations through a high-temperature storage test were made in the same way as in Test Example 1. However, only the measurement after a lapse of 1000 hours from the start of leaving the thermistors was made. FIG. 2 shows a relationship between the internal electrode composition and the resistance change rate.

As shown in FIG. 2, in the case of the thermistor of 0402 size smaller than 0603 size, it is determined that the use of the Pd electrodes as the internal electrodes decreases the resistance change rate, more than the use of the AgPd electrodes. From this result, it is determined that it is desirable to use Pd electrodes as the internal electrodes, in order to enhance the reliability of the thermistor, in particular, of 0402 size or less.

### Examples 4 to 6

Laminated chip-type negative characteristic thermistors were prepared in the same way as in Example 3, except that fired ceramic elements were adapted to 7.0 μm (Example 4), 5.0 μm (Example 5), and 3.0 μm (Example 6) in ceramic average grain size. It is to be noted that the fired ceramic average grain sizes were adjusted by adjusting the average particle sizes of raw material powders for the Mn—Ni—Ti based material. Specifically, the fired ceramic average grain sizes were adjusted by adjusting the amounts of organic binders in ceramic green sheets and adjusting the firing temperatures.

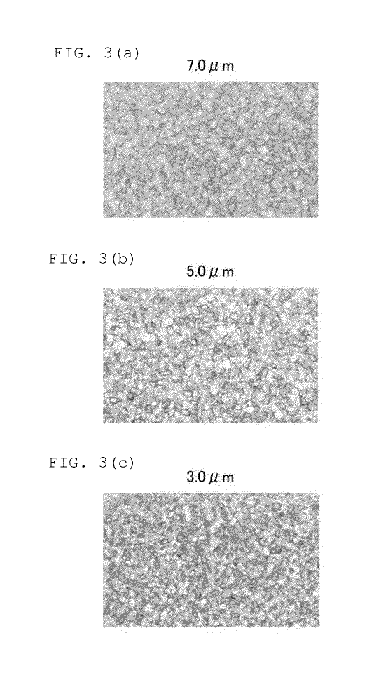

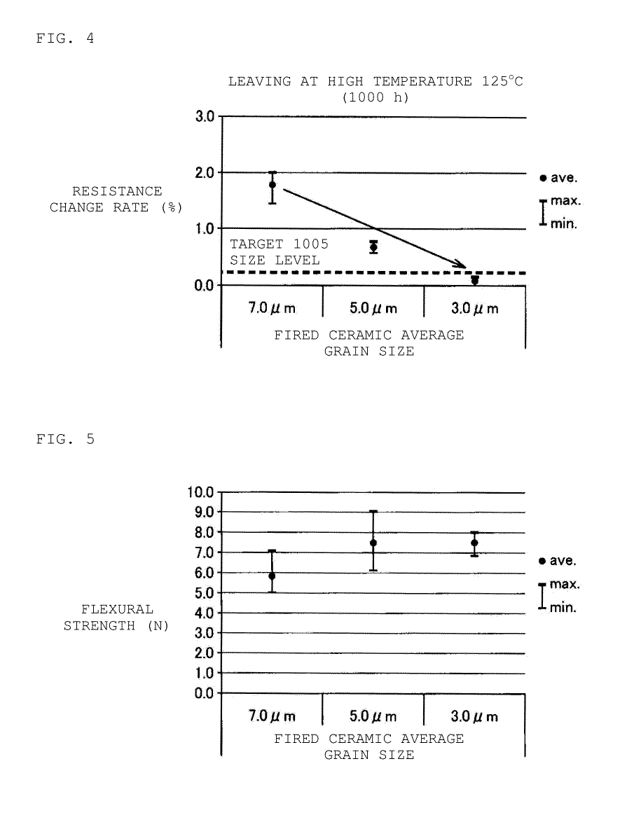

FIGS. 3(a) to 3(c) show electron micrographs of ceramic element surfaces of the laminated chip-type negative characteristic thermistors according to Examples 4 to 6.

### Test Example 3

On the laminated chip-type negative characteristic thermistors according to Examples 4 to 6, reliability evaluations through a high-temperature storage test were made in the same way as in Test Example 2. FIG. 4 shows a relationship between the average grain sizes for ceramic grains and the resistance change rate.

As shown in FIG. 4, it is determined that the ultraminiature thermistor of 0402 size has environment resistance improved by including the internal electrodes composed of Pd and making the fired ceramic grains into fine grains. It is to be noted that when the average grain size is 3.0 μm, environment resistance is achieved which is equivalent (a dotted line in the figure) to that of the larger size such as the 0603 size and the 1005 size.

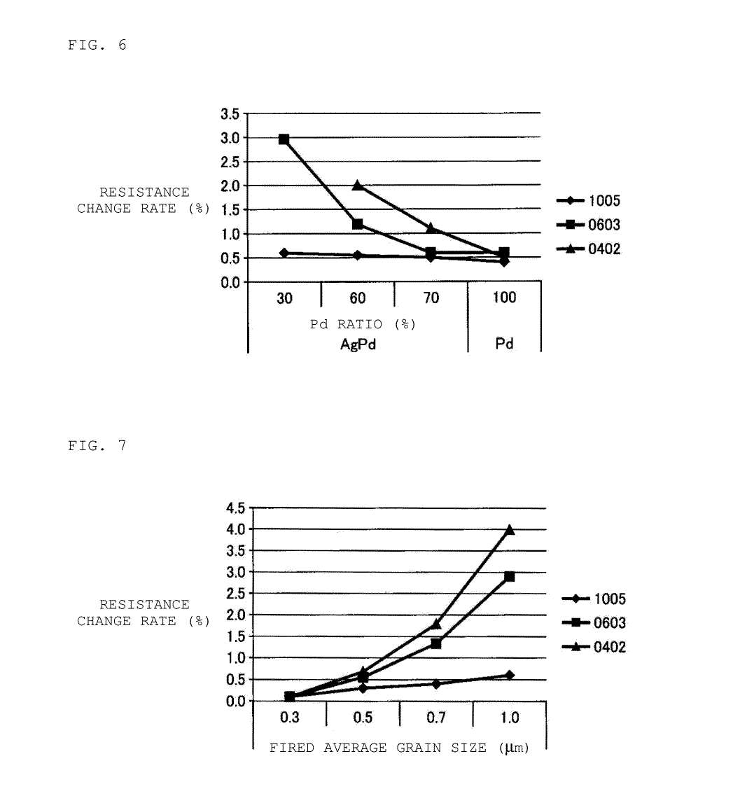

Furthermore, on the laminated chip-type negative characteristic thermistors according to Examples 4 to 6, the flexural strength was measured. Specifically, the body strength of the chip (after the formation of external electrodes and plating) as a finished product was measured by putting a load on the center of the chip with the use of a probe. FIG. 5 shows a relationship between the average grain sizes for ceramic grains and the flexural strength.

As shown in FIG. 5, it is determined that the mechanical strength of the laminated chip-type negative characteristic thermistor can be also improved by making the fired ceramic grains into fine grains.

### Test Example 4

In combinations of firing temperatures and internal electrode compositions as shown in Tables 1 to 3, laminated chip-type negative characteristic thermistors were prepared in the same way as in Example 1, and subjected to a reliability evaluation through a high-temperature storage test in the same way as in Test Example 2. It is to be noted that in the sizes of the laminated chip-type negative characteristic thermistors are respectively 1005 size, 0603 size, and 0402 size in Tables 1 to 3. Tables 1 to 3 show the results of the reliability evaluations on the laminated chip-type negative characteristic thermistors in each combination. It is to be noted that in Tables 1 to 3, the result is shown as ◯ in the case of the resistance change rate of 1% or less, whereas the result is shown as X in the case of the resistance change rate in excess of 1%.

TABLE 1

| | |
|---|---|
| AgPd | Pd |

| | |
|---|---|
| | Pd Ratio of |
| | Internal Electrode |
| 1005 Size | (weight %) |

| | | | | |
|---|---|---|---|---|
| Reliability | 30 | 50 | 70 | 100 |

| | | | | | |
|---|---|---|---|---|---|
| Firing | 1090 | ◯ | ◯ | ◯ | ◯ |
| Temperature | 1110 | ◯ | ◯ | ◯ | ◯ |
| | 1130 | X | X | ◯ | ◯ |
| | 1150 | X | X | X | ◯ |

TABLE 2

| | |
|---|---|
| AgPd | Pd |

| | |
|---|---|
| | Pd Ratio of |
| | Internal Electrode |
| 0603 Size | (weight %) |

| | | | | |
|---|---|---|---|---|
| Reliability | 30 | 50 | 70 | 100 |

| | | | | | |
|---|---|---|---|---|---|
| Firing | 1090 | X | X | X | X |
| Temperature | 1110 | X | X | ◯ | ◯ |
| | 1130 | X | X | ◯ | ◯ |
| | 1150 | X | X | ◯ | ◯ |

TABLE 3

| | | AgPd | | | | | |
|---|---|---|---|---|---|---|---|
| | | Pd Ratio of Internal Electrode (weight %) | | | | | Pd |
| 0402 Size Reliability | | 30 | 50 | 70 | 80 | 90 | 100 |
| Firing | 1090 | X | X | X | X | X | X |
| Temperature | 1110 | X | X | X | X | X | ◯ |
| | 1130 | X | X | X | X | ◯ | ◯ |
| | 1150 | X | X | X | X | ◯ | ◯ |
| | 1170 | X | X | X | X | X | ◯ |

From Tables 1 to 3, it is determined that the 1005 size can use internal electrodes with a low Pd ratio because even firing carried out at relatively low temperatures achieves reliability, whereas the 0603 size and 0402 size have difficulty in achieving desired reliability by firing at relatively low temperatures, require firing at high temperatures in order to improve the reliability of the thermistors, and require the use of internal electrodes with a high Pd ratio.

### Test Example 5

In combinations of chip sizes and internal electrode compositions as shown in Table 4, laminated chip-type negative characteristic thermistors were prepared in the same way as in Example 1, and subjected to a reliability evaluation through a high-temperature storage test in the same way as in Test Example 2. Table 4 shows the respective resistance change rates. In addition, the results in Table 4 are shown in FIG. 6 in a graphic form.

TABLE 4

| | |
|---|---|
| AgPd | Pd |

Pd Ratio of
Internal Electrode
(weight %)

| | | 30 | 60 | 70 | 100 |
|---|---|---|---|---|---|
| Chip Size | 1005 | 0.6 | 0.6 | 0.5 | 0.4 |
| | 0603 | 3.0 | 1.2 | 0.6 | 0.6 |
| | 0402 | — | 2.0 | 1.1 | 0.5 |

From Table 4 and FIG. 6, it is determined that the 1005 size undergoes a small decrease in resistance change rate even in the case of the increased Pd ratio in the internal electrodes, whereas the 0603 size and 0402 size undergo a significant decrease in resistance change rate by the increased Pd ratio in the internal electrodes, thereby resulting in the extremely increased effect of improving the reliability of the thermistors.

### Test Example 6

In combinations of chip sizes and internal electrode compositions as shown in Table 5, laminated chip-type negative characteristic thermistors were prepared in the same way as in Examples 4 to 6, and subjected to a reliability evaluation through a high-temperature storage test in the same way as in Test Example 2. Table 5 shows the respective resistance change rates. In addition, the results in Table 5 are shown in FIG. 7 in a graphic form.

TABLE 5

Fired Grain
Size (μm)

| | | 0.3 | 0.5 | 0.7 | 1.0 |
|---|---|---|---|---|---|
| Chip Size | 1005 | 0.1 | 0.3 | 0.4 | 0.6 |
| | 0603 | 0.1 | 0.6 | 1.3 | 2.9 |
| | 0402 | 0.1 | 0.7 | 1.8 | 4.0 |

From Table 5 and FIG. 7, it is determined that the 1005 size undergoes a small decrease in resistance change rate even in the case of the reduced average grain size for the fired ceramic grains, whereas the 0603 size and 0402 size undergo a significant decrease in resistance change rate by the reduced average grain size for the fired ceramic grains, thereby resulting in the extremely increased effect of improving the reliability of the thermistors.

The embodiments and working examples disclosed herein are all to be considered by way of example in all respects, but not limiting. The scope of the present invention is specified by the claims, but not the above description, and intended to encompass all modifications within the spirit and scope equivalent to the claims.

What is claimed is:

1. A laminated chip-type negative characteristic thermistor of 0603 size or less, the thermistor comprising:
a ceramic element comprising a ceramic material containing Mn and Ni as its main constituents and containing Ti; and
an internal electrode containing Pd ratio of 70 weight % or more.

2. The laminated chip-type negative characteristic thermistor according to claim 1, wherein the ceramic element is 24 μm or less in thickness.

3. The laminated chip-type negative characteristic thermistor according to claim 1, wherein a molar ratio between Mn and Ni meets 55/45≦a/b≦90/10 when a molar quantity of Mn and a molar quantity of Ni are respectively denoted by a and b.

4. The laminated chip-type negative characteristic thermistor according to claim 3, wherein, when a total molar quantity of Mn and Ni is 100 parts by mole, a content of Ti is 0.5 parts by mole or more and 25 parts by mole or less.

5. The laminated chip-type negative characteristic thermistor according to claim 1, wherein the ceramic material further contains Co, a content of Mn is 0.1 mol % or more and 90 mol % or less, a content of Ni is 0.1 mol % or more and 45 mol % or less, a content of Co at 0.1 mol % or more and 90 mol % or less, and a sum of Mn, Ni, and Co is 100 mol %.

6. The laminated chip-type negative characteristic thermistor according to claim 5, wherein, when a total molar quantity of Mn, Ni, and Co in the ceramic material is 100 parts by mole, a content of Ti is 0.5 parts by mole or more and 30 parts by mole or less.

7. A method for manufacturing the negative characteristic thermistor according to claim 1, the method comprising firing the negative characteristic thermistor containing the ceramic element at a temperature of 1100° C. or higher.

8. The method for manufacturing the laminated chip-type negative characteristic thermistor according to claim 7, wherein an average diameter of particles in ceramic crystals of the ceramic element is 3.0 μm or less after the firing.

9. A laminated chip-type negative characteristic thermistor of 0402 size or less, the thermistor comprising:
a ceramic element comprising a ceramic material containing Mn and Ni as its main constituents and containing Ti; and
an internal electrode composed of Pd.

10. The laminated chip-type negative characteristic thermistor according to claim 9, wherein the ceramic element is 16 μm or less in thickness.

11. The laminated chip-type negative characteristic thermistor according to claim 9, wherein a molar ratio between Mn and Ni meets 55/45≦a/b≦90/10 when a molar quantity of Mn and a molar quantity of Ni are respectively denoted by a and b.

12. The laminated chip-type negative characteristic thermistor according to claim 11, wherein, when a total molar quantity of Mn and Ni is 100 parts by mole, a content of Ti is 0.5 parts by mole or more and 25 parts by mole or less.

13. The laminated chip-type negative characteristic thermistor according to claim 9, wherein the ceramic material further contains Co, a content of Mn is 0.1 mol % or more and 90 mol % or less, a content of Ni is 0.1 mol % or more and 45 mol % or less, a content of Co at 0.1 mol % or more and 90 mol % or less, and a sum of Mn, Ni, and Co is 100 mol %.

14. The laminated chip-type negative characteristic thermistor according to claim 13, wherein, when a total molar quantity of Mn, Ni, and Co in the ceramic material is 100 parts by mole, a content of Ti is 0.5 parts by mole or more and 30 parts by mole or less.

15. A method for manufacturing the negative characteristic thermistor according to claim 9, the method comprising firing the negative characteristic thermistor containing the ceramic element at a temperature of 1100° C. or higher.

16. The method for manufacturing the laminated chip-type negative characteristic thermistor according to claim 15, wherein an average diameter of particles in ceramic crystals of the ceramic element is 3.0 μm or less after the firing.
